(19) United States
(12) Patent Application Publication
(10) Pub. No.: US 2007/0077817 A1
(43) Pub. Date: Apr. 5, 2007

(54) Power supply apparatus

(75) Inventor: Guo-Fu Guo, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/518,794

(22) Filed: Sep. 11, 2006

(30) Foreign Application Priority Data
Sep. 30, 2005 (CN) 200510100095.5

(51) Int. Cl. H01R 9/03

(52) U.S. Cl. 439/610

(57) ABSTRACT

A power supply apparatus includes a universal serial bus (USB) cable, a charging cable, and a regulation resistance. A first terminal and a second terminal of the regulation resistance are connected to a power pin and a ground pin of a USB interface of a personal computer respectively via the USB cable, a third terminal of the regulation resistance is connected to the charging cable. The power supply apparatus can be utilized to offer different output voltages in accordance with different external devices.

### BACKGROUND OF THE INVENTION

1. Field of the Invention

The present invention relates in general to a power supply apparatus, and more particularly to a power supply apparatus with USB interface which can provide varied power to external devices connected to a personal computer.

2. General Background

The USB (Universal Serial Bus) interface is used widely on computers for connecting external devices, furthermore, the USB interface can be extended for use on many computer external devices for connecting with each other. If the USB interface is installed on a mobile phone or a digital camera, the mobile phone or the digital camera can get electric power from the computer USB interface for charging a battery of the mobile phone or the digital camera.

Most mobile phones require 3.7V for charging the battery, but the USB interface provides 5V.

What is needed, therefore, is a power supply apparatus with USB interface whose output voltage can be varied for use with a variety of devices.

### SUMMARY

An exemplary power supply apparatus includes a USB cable, a charging cable, and a regulation resistance. A first terminal and a second terminal of the regulation resistance are connected to a power pin and a ground pin of a USB interface of a personal computer respectively via the USB cable, a third terminal of the regulation resistance is connected to the charging cable.

The power supply apparatus can be utilized to offer different output voltages in accordance with different external devices.

Other advantages and novel features will become more apparent from the following detailed description of preferred embodiments when taken in conjunction with the accompanying drawings, in which:

### BRIEF DESCRIPTION OF THE DRAWINGS

FIG. 1 is a block diagram of a power supply apparatus in accordance with a preferred embodiment of the present invention; and

FIG. 2 is a circuit diagram of FIG. 1.

### DETAILED DESCRIPTION OF THE INVENTION

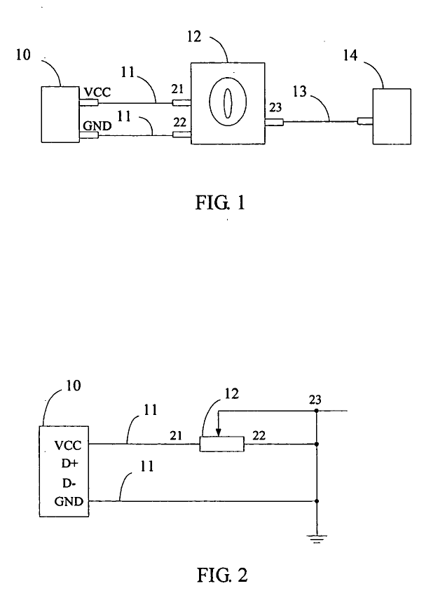

FIG. 1 and FIG. 2 show a power supply apparatus with USB interface 10 converting power to an external device 14. The USB interface 10 comprises 4 pins in the current USB pin out definition—VCC, GND, D+, and D−. VCC is a 5V power pin, GND is a ground pin, and D+ and D− are differential data I/O pins.

The power supply apparatus comprises a USB cable 11, a regulation resistance 12, and a charging cable 13. The regulation resistance 12 is a three-terminal resistor with an adjustable sliding contact shown by the arrow (FIG. 2). A first terminal 21 and a second terminal 22 of the regulation resistance 12 are connected to the power pin VCC and the ground pin GND of the USB interface 10 respectively, and a third terminal 23 is connected to the charging cable 13. The third terminal 23 is the sliding contact of the regulation resistance 12. The voltages selectable at the third terminal 23 are marked on a dial mounted on the surface of the regulation resistance 12.

The charging cable 13 is connected to the external device 14, and a connector of the charging cable 13 is selected according to the specification of the external device 14.

In this embodiment, the data I/O pins D+ and D− are not used, because the USB interface 10 only provides power to the external device 14 and does not communicate with the external device 14.

The power supply apparatus provides voltage to the external device 14, the USB cable 11 is plugged into the USB connector of a PC, the charging cable 13 is connected to the external device 14. When the position of the third terminal 23 is changed (by turning the dial on the regulation resistance 12), the resistance between the first terminal 21 and the third terminal 23 is therefore changed, and the voltage output at the third terminal 23 is changed. Thus, the power supply apparatus can provide varied voltage to the external device 14. When the third terminal 23 is at the first terminal 21 of the regulation resistance 12, the voltage output at the third terminal 23 is 5V, and the voltage provided to the external device 14 is 5V. When the third terminal 23 is at the second terminal 22 of the regulation resistance 12, the voltage output at the third terminal 23 is 0V, and the voltage provided to the external device 14 is 0V. Users can select the output voltage according to the specification of the external device 14 to be anywhere from 0V to 5V.

If the external device 14 to be charged is a 3.7V mobile phone, the USB cable 11 is plugged into the USB connector of a PC, the charging cable 13 is connected to the mobile phone, then the dial is turned to a marked position of 3.7V.

The power supply apparatus can also provide power to the other external devices such as a digital camera or a digital video camera.

It is to be understood, however, that even though numerous characteristics and advantages of the present embodiment has been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power supply apparatus comprising:
a universal serial bus (USB) cable;
a charging cable; and
a regulation resistance, a first terminal and a second terminal of the regulation resistance connected to a power pin and a ground pin of a USB interface of a personal computer respectively via the USB cable, a third terminal of the regulation resistance connected to the charging cable.

2. The power supply apparatus as claimed in claim 1, wherein the regulation resistance is a three-terminal resistor with a sliding contact, and the third terminal is the sliding contact.

3. The power supply apparatus as claimed in claim 1, wherein the power supply apparatus has an output voltage selectable from 0V to 5V.

4. A power supply apparatus adapted for charging an external device comprising:
a universal serial bus (USB) connector connected with a USB port of a personal computer;
a second connector connected with a connector of the external device; and
a regulation resistance connecting the USB connector and the second connector for charging or powering the external device with a selectable voltage from the personal computer.

5. The power supply apparatus as claimed in claim 4, wherein the regulation resistance is a three-terminal resistor with a sliding contact.

6. The power supply apparatus as claimed in claim 4, wherein a first terminal and a second terminal of the regulation resistance are connected to a power pin and a ground pin of the USB port respectively via a USB cable, a third terminal of the regulation resistance is connected to the second connector.

7. The power supply apparatus as claimed in claim 4, wherein the power supply apparatus has an output voltage arranged from 0V to 5V.

8. An apparatus for supplying power to an external device, comprising:
a power source;
at least one input terminal electrically connectable with said power source;
an output terminal electrically connectable with an external device to be powered; and
a regulation resistance electrically connectable between said at least one input terminal and said output terminal so as to provide more than one electrical resistance between said at least one input terminal and said output terminal in order for regulating power supplied from said power source toward said external device via said terminals to a selective power voltage for use of said external device.

9. The apparatus as claimed in claim 8, wherein said selective power voltage is available from 0V to 5V.

10. The apparatus as claimed in claim 8, wherein said power source and at least one input terminal are electrically connectable with each other via universal serial bus (USB) connection.
